(19) United States
(12) Patent Application Publication
(10) Pub. No.: US 2018/0134624 A1
(43) Pub. Date: May 17, 2018

(54) ZIRCONIUM OXIDE COMPOSITE CERAMIC AND PREPARATION METHOD THEREFOR

(71) Applicant: SUNTECH ADVANCED CERAMICS (SHENZHEN) CO., LTD., Shenzhen (CN)

(72) Inventors: Hui YANG, Shenzhen (CN); Yicheng TAN, Shenzhen (CN); Qijun XIANG, Shenzhen (CN)

(73) Assignee: SUNTECH ADVANCED CERAMICS (SHENZHEN) CO., LTD., Shenzhen (CN)

(21) Appl. No.: 15/567,057

(22) PCT Filed: Apr. 27, 2015
(86) PCT No.: PCT/CN2015/077512

§ 371 Date: Oct. 16, 2017

(51) Int. Cl. C04B 35/48; C04B 35/64; C04B 35/626; H01B 1/08

(52) U.S. Cl. CPC C04B 35/48; C04B 2235/661; C04B 35/6262; C04B 35/62695; H01B 1/08; C04B 2235/3244; C04B 2235/3225; C04B 2235/3272; C04B 2235/3279; C04B 2235/3241; C04B 2235/3217; C04B 2235/3243; C04B 2235/3232; C04B 2235/3284; C04B 2235/3293; C04B 2235/3222; C04B 2235/5454; C04B 2235/606; C04B 2235/6562; C04B 2235/6567; C04B 35/64

(57) ABSTRACT

Provided are a zirconium oxide composite ceramic and a preparation method therefor. The zirconium oxide composite ceramic comprises by mass percentage: 65% to 80% of a zirconium oxide matrix, 10% to 30% of a conductive material, and 2% to 11% of a nano-reinforcing material. The conductive material is selected from at least one of a non-ferrous metal oxide, a white metal oxide, a compound having a perovskite structure and a compound having a spinel structure. The zirconium oxide composite ceramic has excellent antistatic properties and high mechanical properties.

### FIELD OF THE INVENTION

The present disclosure relates to a zirconia composite ceramic and a preparation method thereof.

### BACKGROUND OF THE INVENTION

When two objects are rubbing against each other, the electrons in an object go to another object due to the weak bond of the nucleus, such that the object that get electrons are negatively charged because the negative charge is more than positive charge thereof; the object that lost electrons are positively charged because the positive charge is more than negative charge thereof, which is the phenomenon of electrification by friction. The electrical energy carried by the object is called “static electricity” and an electrostatic discharge occurs when it accumulates to a certain extent. In today's increasingly developed electronics industry, a variety of microelectronics, optoelectronic components are widely used, and electrostatic discharge can destroy the electronic components, change the electrical properties of semiconductor components, and damage the electronic system, resulting in the entire equipment malfunction or failure. At the same time, the static spark is generated when electrostatic discharge is released, which may easy to ignite flammable and explosive materials, causing great danger and economic losses.

Ceramic materials have good wear resistance, corrosion resistance, high temperature resistance, good rigidity, and so on, which are the ideal anti-static materials. The currently disclosed method of preparing the antistatic ceramic material may reduce the resistivity of the ceramic material to 10⁵ to 10⁹ Ω·cm by adding the second phase, i.e., the conductive phase, into the ceramic matrix, so as to achieve the purpose of static dissipation.

Since the current antistatic ceramic material is prepared by the method of physically mixing the ceramic matrix and the conductive phase powder, it is necessary to add more conductive phase (the general ratio is 20% to 40% by mass fraction) in order to achieve the required resistivity, which undoubtedly greatly increased the impurity content of ceramic matrix, reducing the mechanical properties of the ceramic itself.

### SUMMARY

Therefore, it is necessary to provide a zirconia composite ceramic and a preparation method thereof, which has excellent antistatic performance and high mechanical properties.

A zirconia composite ceramic includes: by weight percentage, 65% to 80% of zirconia matrix, 10% to 30% of conductive material, and 2% to 11% of nanometer reinforcing material. The conductive material is at least one selected from the group consisting of nonferrous metal oxide, white metal oxide, compound having perovskite structure, and compound having spinel structure. The colored oxide is at least one selected from the group consisting of CuO, Cu₂O, V₂O₅, NiO, MnO, MnO₂, CoO, Co₂O₃, Co₃O₄, Fe₂O₃, FeO, Fe₃O₄, and Cr₂O₃. The white oxide is at least one selected from the group consisting of ZnO, SnO₂, and TiO₂. The compound having perovskite structure is at least one selected from the group consisting of CaTiO₃, BaTiO₃, LaCrO₃, LaSr_{0.1}Cr_{0.9}O₃, SrTiO₃, and LaFeO₃. The compound having spinel structure has a formula of AB₂O₄, wherein A is at least one selected from the group consisting of Mg, Fe, Zn, and Mn; B is at least one selected from the group consisting of Al, Cr, and Fe.

In one embodiment, the zirconia matrix includes, by weight percentage, 2% to 10% of stabilizer and 90% to 98% of zirconia, the stabilizer is at least one selected from the group consisting of yttria, magnesium oxide, calcium oxide, and cerium oxide.

In one embodiment, the nanometer reinforcing material is at least one selected from the group consisting of nano-zirconia and nano-alumina.

A method of preparing the aforementioned zirconia composite ceramic includes the following steps of:

providing a zirconium oxychloride solution and a metal ion solution corresponding to the conductive material according to an amount of the zirconia matrix and the conductive material in the zirconia composite ceramic, and combining the zirconium oxychloride solution and the metal ion solution to obtain a mother liquor;

providing a dispersant solution and heating the dispersant solution to a temperature of 60° C. to 65° C., wherein a mass ratio of a dispersant in the dispersant solution to the zirconia in the zirconia matrix ranges from 0.5:99.5 to 1:99;

adding an ammonia having a concentration of 2 mol/L to 3 mol/L and the mother liquor into the dispersant solution simultaneously, controlling the reaction temperature at 60° C. to 65° C. and the reaction pH at 8 to 10, aging for 2 hours to 5 hours after the reaction is finished, drying after filtration to obtain a precursor;

sintering the precursor at a temperature of 800° C. to 1100° C. for 1 hour to 5 hours to obtain a bulk material;

ball-milling the bulk material and a nanometer reinforcing material for 24 hours to 48 hours to obtain zirconia composite ceramic powder;

granulating the zirconia composite ceramic powder to form a green body; and

heating the green body slowly to a temperature of 1280° C. to 1520° C. for sintering to obtain the zirconia composite ceramic.

In one embodiment, in the step of heating the green body slowly to the temperature of 1280° C. to 1520° C. for sintering, a temperature is raised to 700° C. at a heating rate of 0.5° C./min to 3° C./min, and then the temperature is raised to 1280° C. to 1520° C. at a heating rate of 4° C./min to 5° C./min.

In one embodiment, in the step of providing the zirconium oxychloride solution and the metal ion solution corresponding to the conductive material according to the amount of the zirconia matrix and the conductive material in the zirconia composite ceramic, the zirconium oxychloride solution has a concentration of 80 g/L to 85 g/L, the amount of the conductive material in the zirconia composite ceramic is converted to an amount of an metal oxide, the metal oxides are dissolved with nitric acid to formulate the metal ion solutions having a concentration of 0.4 mol/L to 0.6 mol/L, respectively.

In one embodiment, in the step of drying after filtration to obtain the precursor, a precipitate obtained after the filtration is rinsed with deionized water, and the precipitate after rinsing is lyophilized at 10 Pa to 40 Pa for 2 hours to 5 hours to obtain the precursor.

In one embodiment, the dispersant in the dispersant solution is at least one selected from the group consisting of SD-05, D3005, D900, and ammonium polyacrylate; and the dispersant solution has a concentration of 10 g/L to 30 g/L.

In one embodiment, in the step of granulating the zirconia composite ceramic powder to form the green body, the zirconia composite ceramic powder is spray granulated to obtain a powder having a particle size of 0.7 μm to 1 μm and a specific surface area of 8 m²/g to 11 m²/g.

In one embodiment, in the step of sintering the precursor at a temperature of 800° C. to 1100° C. for 1 hour to 5 hours to obtain the bulk material, the temperature is raised to 800° C. to 1100° C. at a heating rate of 1° C./min to 3° C./min.

In the aforementioned zirconia composite ceramic, the added conductive material has properties of a conductor or a semiconductor, the addition of the conductive material to the zirconia matrix can significantly reduce the resistivity of the zirconia matrix itself. Meanwhile, the added conductive material will not be oxidative decomposed during sintering at high temperature, so as to avoid the generation of pores inside the zirconia composite ceramics, thereby improving the antistatic properties and compactness of the zirconia matrix. The nanometer reinforcing material may absorb part of the fracture energy, which result in a dual effect of reinforcement and toughening. The aforementioned method of preparing the zirconia composite ceramic is carried out by a coprecipitation method using the ammonia as the precipitant. The reaction produces a uniform precipitate followed by sintering. Compared with the conventional physical mixing method, the aforementioned method enables the conductive material to be more evenly distributed in the zirconia matrix, and the conductive material may even enter the zirconia lattice to form a continuous and conducting conductive circuit, such that the amount of the conductive material can be reduced and the mechanical properties of zirconia composite ceramics can be improved. Since the conductive material is evenly distributed in the zirconia matrix, the local resistivity of the overall zirconia composite ceramic is constant, such that static electricity can be prevented from forming an unsafe fast discharge on the surface of the zirconia composite ceramic.

### BRIEF DESCRIPTION OF THE DRAWINGS

FIG. 1 is a flowchart of a method of preparing a zirconia composite ceramic according to an embodiment.

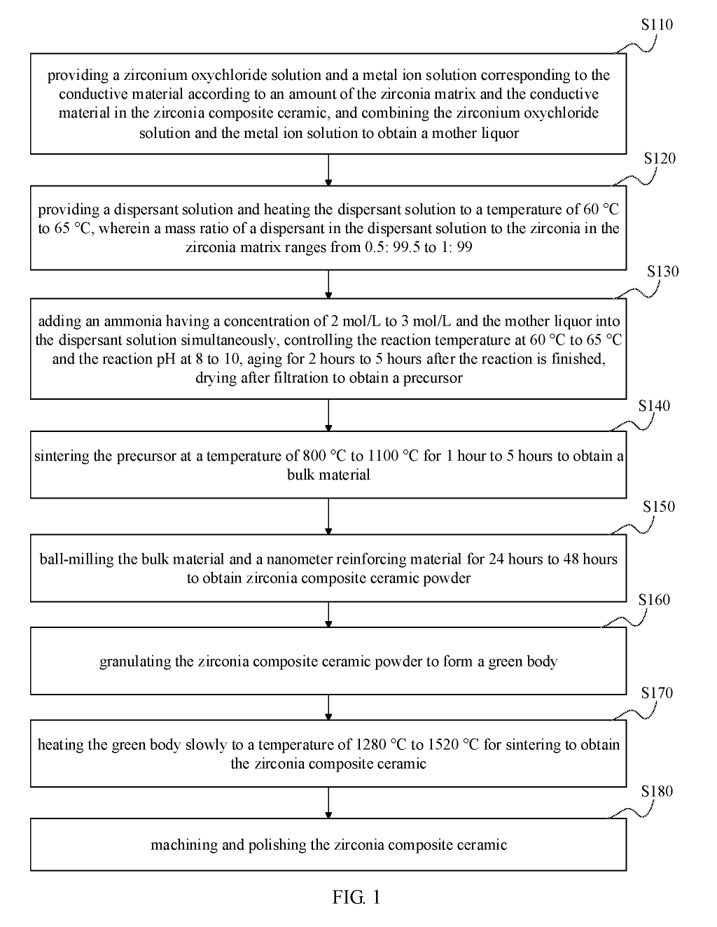

### DETAILED DESCRIPTION OF THE EMBODIMENTS

In order to make the above and other objects, features and advantages of the present invention become more apparent, the specific embodiments will be described in detail in combination with the accompanying drawings. Numerous specific details are described hereinafter in order to facilitate a thorough understanding of the present disclosure. The various embodiments of the disclosure may, however, be embodied in many different forms and should not be construed as limited to the specific embodiments set forth hereinafter, and people skilled in the art can make similar modifications without departing from the spirit of the present disclosure.

A zirconia composite ceramic includes, by weight percentage, 65% to 80% of zirconia matrix, 10% to 30% of conductive material, and 2% to 11% of nanometer reinforcing material.

The conductive material is at least one selected from the group consisting of nonferrous metal oxide, white metal oxide, compound having perovskite structure, and compound having spinel structure.

The colored oxide is at least one selected from the group consisting of CuO, Cu₂O, V₂O₅, NiO, MnO, MnO₂, CoO, Co₂O₃, Co₃O₄, Fe₂O₃, FeO, Fe₃O₄, and Cr₂O₃.

The white oxide is at least one selected from the group consisting of ZnO, SnO₂, and TiO₂.

The compound having perovskite structure is at least one selected from the group consisting of CaTiO₃, BaTiO₃, LaCrO₃, LaSr_{0.1}Cr_{0.9}O₃, SrTiO₃, and LaFeO₃.

The compound having spinel structure has a formula AB₂O₄, wherein A is at least one selected from the group consisting of Mg, Fe, Zn, and Mn; B is at least one selected from the group consisting of Al, Cr, and Fe. The compound having spinel structure may be MgAl₂O₄, FeAl₂O₄, ZnCr₂O₄, and MnFe₂O₄.

Preferably, the zirconia matrix includes, by weight percentage, 2% to 10% of a stabilizer and 90% to 98% of zirconia, the stabilizer is at least one selected from the group consisting of yttria, magnesium oxide, calcium oxide, and cerium oxide. The addition of the stabilizer can increase the toughness of zirconia.

Preferably, the nanometer reinforcing material is at least one selected from the group consisting of nano-zirconia and nano-alumina.

In the aforementioned zirconia composite ceramic, the added conductive material has properties of a conductor or a semiconductor, the addition of the conductive material to the zirconia matrix can significantly reduce the resistivity of the zirconia matrix itself. Meanwhile, the added conductive material will not be oxidative decomposed during sintering at high temperature, so as to avoid the generation of pores inside the zirconia composite ceramics, thereby improving the antistatic properties and compactness of the zirconia matrix. After sintering the added conductive material, a conductive or semi-conductive discrete grain phase will be formed in the zirconia matrix, such that the resistivity of the zirconia composite ceramic can be reduced to about 10⁵ to 10⁹ Ω·cm. The addition of the nanometer reinforcing material can increase the fracture stress due to the mismatch of thermal expansion and elastic modulus, while the nanometer reinforcing material can absorb part of the fracture energy, such that the nanometer reinforcing material has the dual effect of reinforcement and toughening. The presence of the pinning, deflection, and bending effect of crack propagation in the dispersion strengthened material may also result in a toughening effect, which is not affected by temperature, thus serving as an effective high temperature toughening mechanism.

A method of preparing the aforementioned zirconia composite ceramic includes the following steps of:

In step S110, a zirconium oxychloride solution and a metal ion solution corresponding to the conductive material are provided in accordance with an amount of the zirconia matrix and the conductive material in the zirconia composite ceramic, and a mother liquor is obtained by combining the zirconium oxychloride solution and the metal ion solution.

Preferably, the zirconium oxychloride solution has a concentration of from 80 g/L to 85 g/L.

If the conductive material is nonferrous metal oxide or white metal oxide, the corresponding amount of the metal oxide is weighed and is dissolved with nitric acid to formulate the metal ion solution having a concentration of 0.4 mol/L to 0.6 mol/L.

If the conductive material is compound having perovskite structure and compound having spinel structure, the amount of the conductive material is converted into an amount of the corresponding metal oxide, and then the corresponding metal oxides are weighed and are dissolved with nitric acid to formulate the metal ion solutions having a concentration of 0.4 mol/L to 0.6 mol/L, respectively.

For example, when the conductive material is 1 mol of LaCrO₃, 0.5 mol of Cr₂O₃ and 0.5 mol of La₂O₃ are added, followed by formulating 0.4 mol/L to 0.6 mol/L of nitrate solution.

Preferably, the zirconia matrix further includes a stabilizer. The zirconia matrix includes, by weight percentage, 2% to 10% of stabilizer and 90% to 98% of zirconia. The stabilizer is at least one selected from the group consisting of yttria, magnesium oxide, calcium oxide, and cerium oxide, thus the mother liquor also includes the corresponding metal ion of the stabilizer. Furthermore, in this step, the corresponding amount of the stabilizer is weighed and is dissolved with nitric acid to formulate the metal ion solution having a concentration of 0.4 mol/L to 0.6 mol/L, and the metal ion solution is added to the mother liquor.

In step S120, a dispersant solution is provided, and the dispersant solution is heated to a temperature of 60° C. to 65° C., wherein a mass ratio of a dispersant in the dispersant solution to the zirconia in the zirconia matrix ranges from 0.5:99.5 to 1:99.

Preferably, the dispersant solution has a concentration of 10 g/L to 30 g/L.

Preferably, the dispersant in the dispersant solution is at least one selected from the group consisting of SD-05, D3005, D900, and ammonium polyacrylate.

Preferably, in the step of heating the dispersant solution to the temperature of 60° C. to 65° C., a heating rate thereof is 1° C./min to 2° C./min.

In step S130, an ammonia having a concentration of 2 mol/L to 3 mol/L and the mother liquor are adding into the dispersant solution simultaneously to carry out reaction, the reaction temperature is controlled in a range from 60° C. to 65° C. and the reaction pH is in a range from 8 to 10. The mixture is aged for 2 hours to 5 hours after the reaction is finished, then dried after filtration to obtain a precursor.

Preferably, when the ammonia and the mother liquor are added to the dispersant solution, the flow of the two liquids is controlled by means of dropping to maintain a pH of 8 to 10.

Preferably, when the ammonia having the concentration of 2 mol/L to 3 mol/L and the mother liquor are simultaneously added to the dispersant solution, the reaction is continuously stirred to produce a hydroxide precipitate.

Preferably, a precipitate obtained after the filtration is rinsed with deionized water, and the precipitate after rinsing is lyophilized at 10 Pa to 40 Pa for 2 hours to 5 hours to obtain the precursor. Furthermore, rinsing with deionized water 5 times.

Preferably, the ammonia having the concentration of 2 mol/L to 3 mol/L is formulated by ammonia having a mass fraction of 25% and deionized water before use.

In step S140, the precursor is sintered at a temperature of 800° C. to 1100° C. for 1 hour to 5 hours to obtain a bulk material.

Preferably, the temperature is raised to 800° C. to 1100° C. at a heating rate of 1° C./min to 3° C./min.

Preferably, the sintering is carried out in an air resistance furnace.

In step S150, the bulk material and the nanometer reinforcing material are ball milled for 24 hours to 48 hours to obtain zirconia composite ceramic powder.

Preferably, the nanometer reinforcing material is at least one selected from the group consisting of nano-zirconia and nano-alumina.

Preferably, the zirconia ball is used as a milling medium, and the mass ratio of the total amount of the bulk material and the nanometer reinforcing material, the zirconia ball, and the water is 1:1 to 3:0.5 to 1.

In step S160, the zirconia composite ceramic powder is granulated to form a green body.

Preferably, the zirconia composite ceramic powder is spray granulated to obtain a powder having a particle size of 0.7 μm to 1 μm and a specific surface area of 8 m²/g to 11 m²/g.

Preferably, the green body is formed by dry pressing, isostatic pressing, injection molding, extrusion molding or gel forming.

In step S170, the green body is slowly heated to a temperature of 1280° C. to 1520° C. for sintering to obtain the zirconia composite ceramic.

Preferably, the temperature is raised to 700° C. at a heating rate of 0.5° C./min to 3° C./min, and then the temperature is raised to 1280° C. to 1520° C. at a heating rate of 4° C./min to 5° C./min. In this step, the temperature rise slowly in the low temperature section, such that the green body is prevented from defects such as cracking, bubbling, and stomata.

Preferably, the sintering is carried out at a temperature of 1280° C. to 1520° C. for 2 hours to 5 hours.

In step S180, the zirconia composite ceramic is machined and polished.

The aforementioned method of preparing the zirconia composite ceramic is carried out by a coprecipitation method using the ammonia as the precipitant. The reaction produces a uniform precipitate followed by sintering. Compared with the conventional physical mixing method, the aforementioned method enables the conductive material to be more evenly distributed in the zirconia matrix, and the conductive material may even enter the zirconia lattice to form a continuous and conducting conductive circuit, such that the amount of the conductive material can be reduced and the mechanical properties of zirconia composite ceramics can be improved. Since the conductive material is evenly distributed in the zirconia matrix, the local resistivity of the overall zirconia composite ceramic is constant, such that static electricity can be prevented from forming an unsafe fast discharge on the surface of the zirconia composite ceramic.

Hereinafter, detailed description will be made with reference to specific examples.

### Example 1

A zirconia composite ceramic includes components of the following mass fraction:

| | |
|---|---|
| Zirconia | 76% |
| Yttrium oxide | 4% |
| Ferric oxide | 1% |
| Nickel oxide | 7% |
| Chromium oxide | 2% |
| Nano-alumina | 10% |

The method of preparing the aforementioned zirconia composite ceramic includes the following steps of:

Step 1: according to the mass ratio of the zirconia in the table, the mass ratio of the zirconia was converted into a mass ratio of zirconium oxychloride in terms of molar ratio, and then 80 g/L aqueous solution was formulated. Next, Y₂O₃, ferric oxide, nickel oxide, and chromium oxide were weighed according to the mass ratio, and then were dissolved with nitric acid to formulate 0.4 mol/L nitrate solution, respectively. Finally, the weighed material solutions were added to the reactor kettle, stirred evenly to form the mother liquor.

Step 2: the reaction and precipitation were carried out by a coprecipitation method. Deionized water having 3 times of the total powder mass and dispersant having 0.5% of the total powder mass were added into the reaction kettle. The dispersant was SD-05, and the temperature was slowly raised to 65° C. at a rate of 1° C./min. The concentrated ammonia having a mass fraction of 25% was selected as a precipitant, deionized water was added in the concentrated ammonia to formulate 3 mol/L precipitant solution. The solution prepared in step 1 and the ammonia were simultaneously added into the reactor kettle, and the reaction temperature was controlled at 60° C. Pay attention to adjust the flow of the two solutions, such that the pH value was maintained at 10, while stirring continuously to produce a hydroxide precipitate until the mother liquor had added. After completion of the reaction, the precipitate was aged for 3 hours, then filtered, and the precipitate was rinsed 5 times with deionized water. The rinsed precipitate was then placed in a lyophilizer, adjusted to a drying pressure of 20 Pa, and was lyophilized for 3 hours, thereby obtaining an antistatic zirconia precursor without hard agglomeration.

Step 3: the precursor obtained in step 2 was heated to 950° C. at a rate of 1° C./min using an air resistance furnace and was held for 2 hours to obtain antistatic zirconia bulk powder.

Step 4: the bulk powder obtained in step 3 and the nano-alumina powder weighed by mass ratio were added to the ball mill together to carry out the wet grinding mixed. The grinding ball adopted a zirconia material grinding ball, the ratio of the material, ball, and water was 1:2:0.5, and the ball-milling time was 30 hours.

Step 5: the ball-milled powder was spray granulated to obtain an antistatic zirconia ceramic powder having a particle size of 0.8 μm and a specific surface area of 9 m²/g.

Step 6: the prepared zirconia antistatic ceramic powder was placed into a dry pressing mould, so as to press to a long strip having a length of 50 mm, a width of 10 mm, and a height of 8 mm.

Step 7: the shaped green body was placed into an air furnace for sintering. The heating rate is 1° C./min below 700° C. and 4° C./min above 700° C., until the maximum sintering temperature had reached. The maximum sintering temperature was 1400° C. and was held for 2.5 hours.

Step 8: the sintered zirconia antistatic ceramic was machined according to requirements to obtain a long strip having a length of 36 mm, a width of 4 mm, and a height of 3 mm. Then the long strip was polished to obtain an antistatic ceramic finished product of qualified size, shape, and surface quality.

### Example 2

An antistatic zirconia ceramic includes components of the following mass fraction:

| | |
|---|---|
| Zirconia | 70% |
| Yttrium oxide | 5% |
| LaSr_{0.1}Cr_{0.9}O₃ | 20% |
| Nano-zirconia | 5% |

The method of preparing the aforementioned zirconia composite ceramic includes the following steps of:

Step 1: according to the mass ratio of the zirconia in the table, the mass ratio of the zirconia was converted into a mass ratio of zirconium oxychloride in terms of molar ratio, and then 82 g/L aqueous solution was formulated. The LaSr_{0.1}Cr_{0.9}O₃ was converted into a molar ratio according to the mass ratio, and then was converted into the mass ratio of the precursor oxide such as lanthanum oxide, strontium oxide, and chromium oxide. Next, several oxides and yttrium oxide were dissolved with nitric acid to formulate 0.5 mol/L nitrate solution, respectively. Finally, the weighed material solutions were added to the reactor kettle, stirred evenly to form the mother liquor.

Step 2: the reaction and precipitation were carried out by a coprecipitation method. Deionized water having 4 times of the total powder mass and dispersant having 0.6% of the total powder mass were added into the reaction kettle. The dispersant was D3005, and the temperature was slowly raised to 62° C. at a rate of 2° C./min. The concentrated ammonia having a mass fraction of 25% was selected as a precipitant, deionized water was added in the concentrated ammonia to formulate 2 mol/L precipitant solution. The solution prepared in step 1 and the ammonia were simultaneously added into the reactor kettle, and the reaction temperature was controlled at 62° C. Pay attention to adjust the flow of the two solutions, such that the pH value was maintained at 9, while stirring continuously to produce a hydroxide precipitate until the mother liquor had added. After completion of the reaction, the precipitate was aged for 4 hours, then filtered, and the precipitate was rinsed 5 times with deionized water. The rinsed precipitate was then placed in a lyophilizer, adjusted to a drying pressure of 25 Pa, and was lyophilized for 2 hours, thereby obtaining an antistatic zirconia precursor without hard agglomeration.

Step 3: the precursor obtained in step 2 was heated to 1000° C. at a rate of 2° C./min using an air resistance furnace and was held for 3 hours to obtain antistatic zirconia bulk powder.

Step 4: the bulk powder obtained in step 3 and the nano-zirconia powder weighed by mass ratio were added to the ball mill together to carry out the wet grinding mixed. The grinding ball adopted a zirconia material grinding ball, the ratio of the material, ball, and water was 1:2.5:0.6, and the ball-milling time was 24 hours.

Step 5: the ball-milled powder was spray granulated to obtain an antistatic zirconia ceramic powder having a particle size of 1 μm and a specific surface area of 8 m²/g.

Step 6: the prepared zirconia antistatic ceramic powder was placed into an isostatic pressing mould, so as to press and process to a long strip having a length of 50 mm, a width of 10 mm, and a height of 8 mm.

Step 7: the shaped green body was placed into an air furnace for sintering. The heating rate is 2° C./min below 700° C. and 5° C./min above 700° C., until the maximum sintering temperature had reached. The maximum sintering temperature was 1360° C. and was held for 2 hours.

Step 8: the sintered zirconia antistatic ceramic was machined according to requirements to obtain a long strip having a length of 36 mm, a width of 4 mm, and a height of 3 mm. Then the long strip was polished to obtain an antistatic ceramic finished product of qualified size, shape, and surface quality.

### Example 3

An antistatic zirconia ceramic includes components of the following mass fraction:

| | |
|---|---|
| Zirconia | 65% |
| Yttrium oxide | 3% |
| Titanium oxide | 30% |
| Nano-alumina | 2% |

The method of preparing the aforementioned zirconia composite ceramic includes the following steps of:

Step 1: according to the mass ratio of the zirconia in the table, the mass ratio of the zirconia was converted into a mass ratio of zirconium oxychloride in terms of molar ratio, and then 81 g/L aqueous solution was formulated. Y₂O₃ and titanium oxide were weighed according to the mass ratio, and then were dissolved with nitric acid to formulate 0.6 mol/L nitrate solution, respectively. Finally, the weighed material solutions were added to the reactor kettle, stirred evenly to form the mother liquor.

Step 2: the reaction and precipitation were carried out by a coprecipitation method. Deionized water having 6 times of the total powder mass and dispersant having 0.8% of the total powder mass were added into the reaction kettle. The dispersant was D900, and the temperature was slowly raised to 63° C. at a rate of 1° C./min. The concentrated ammonia having a mass fraction of 25% was selected as a precipitant, deionized water was added in the concentrated ammonia to formulate 3 mol/L precipitant solution. The solution prepared in step 1 and the ammonia were simultaneously added into the reactor kettle, and the reaction temperature was controlled at 63° C. Pay attention to adjust the flow of the two solutions, such that the pH value was maintained at 8, while stirring continuously to produce a hydroxide precipitate until the mother liquor had added. After completion of the reaction, the precipitate was aged for 3 hours, then filtered, and the precipitate was rinsed 5 times with deionized water. The rinsed precipitate was then placed in a lyophilizer, adjusted to a drying pressure of 30 Pa, and was lyophilized for 5 hours, thereby obtaining an antistatic zirconia precursor without hard agglomeration.

Step 3: the precursor obtained in step 2 was heated to 1050° C. at a rate of 1° C./min using an air resistance furnace and was held for 2.5 hours to obtain antistatic zirconia bulk powder.

Step 4: the bulk powder obtained in step 3 and the nano-alumina powder weighed by mass ratio were added to the ball mill together to carry out the wet grinding mixed. The grinding ball adopted a zirconia material grinding ball, the ratio of the material, ball, and water was 1:2:0.6, and the ball-milling time was 36 hours.

Step 5: the ball-milled powder was spray granulated to obtain an antistatic zirconia ceramic powder having a particle size of 0.9 μm and a specific surface area of 9.5 m²/g.

Step 6: the prepared zirconia antistatic ceramic powder and binder were kneaded at a mass ratio of 80:20. Paraffin accounted for 60%, polyethylene accounted for 20%, and polypropylene accounted for 20% (both the mass fraction) in the binder. After kneading, injection molding was carried out to obtain a long striped injection green body having a length of 50 mm, a width of 10 mm, and a height of 8 mm.

Step 7: the shaped green body was placed into an air furnace for sintering. The heating rate is 0.5° C./min below 700° C. and 4° C./min above 700° C., until the maximum sintering temperature had reached. The maximum sintering temperature was 1320° C. and was held for 3 hours.

Step 8: the sintered zirconia antistatic ceramic was machined according to requirements to obtain a long strip having a length of 36 mm, a width of 4 mm, and a height of 3 mm. Then the long strip was polished to obtain an antistatic ceramic finished product of qualified size, shape, and surface quality.

### Example 4

An antistatic zirconia ceramic includes components of the following mass fraction:

| | |
|---|---|
| Zirconia | 70% |
| Yttrium oxide | 4% |
| Zinc oxide | 10% |
| Tin oxide | 10% |
| Nano-alumina | 6% |

The method of preparing the aforementioned zirconia composite ceramic includes the following steps of:

Step 1: according to the mass ratio of the zirconia in the table, the mass ratio of the zirconia was converted into a mass ratio of zirconium oxychloride in terms of molar ratio, and then 85 g/L aqueous solution was formulated. Next, Y₂O₃, zinc oxide, and tin oxide were weighed according to the mass ratio, and then were dissolved with nitric acid to formulate 0.5 mol/L nitrate solution, respectively. Finally, the weighed material solutions were added to the reactor kettle, stirred evenly to form the mother liquor.

Step 2: the reaction and precipitation were carried out by a coprecipitation method. Deionized water having 5 times of the total powder mass and dispersant having 1% of the total powder mass were added into the reaction kettle. The dispersant was ammonium polyacrylate, and the temperature was slowly raised to 64° C. at a rate of 1° C./min. The concentrated ammonia having a mass fraction of 25% was selected as a precipitant, deionized water was added in the concentrated ammonia to formulate 3 mol/L precipitant solution. The solution prepared in step 1 and the ammonia were simultaneously added into the reactor kettle, and the reaction temperature was controlled at 64° C. Pay attention to adjust the flow of the two solutions, such that the pH value was maintained at 9, while stirring continuously to produce a hydroxide precipitate until the mother liquor had added. After completion of the reaction, the precipitate was aged for 4 hours, then filtered, and the precipitate was rinsed 5 times with deionized water. The rinsed precipitate was then placed in a lyophilizer, adjusted to a drying pressure of 40 Pa, and was lyophilized for 5 hours, thereby obtaining an antistatic zirconia precursor without hard agglomeration.

Step 3: the precursor obtained in step 2 was heated to 1000° C. at a rate of 3° C./min using an air resistance furnace and was held for 2 hours to obtain antistatic zirconia bulk powder.

Step 4: the bulk powder obtained in step 3 and the nano-alumina powder weighed by mass ratio were added to the ball mill together to carry out the wet grinding mixed. The grinding ball adopted a zirconia material grinding ball, the ratio of the material, ball, and water was 1:3:0.5, and the ball-milling time was 48 hours.

Step 5: the ball-milled powder was spray granulated to obtain an antistatic zirconia ceramic powder having a particle size of 0.7 μm and a specific surface area of 11 m²/g.

Step 6: the prepared zirconia antistatic ceramic powder and 5% of binder PVA, 0.8% of plasticizer DOP, 0.5% of dispersant PMMA accounting on the powder mass were mixed evenly, so as to extrude a long strip having a length of 50 mm, a width of 10 mm, and a height of 8 mm.

Step 7: the shaped green body was placed into an air furnace for sintering. The heating rate is 1.5° C./min below 700° C. and 5° C./min above 700° C., until the maximum sintering temperature had reached. The maximum sintering temperature was 1380° C. and was held for 2 hours.

Step 8: the sintered zirconia antistatic ceramic was processed according to requirements to obtain a long strip having a length of 36 mm, a width of 4 mm, and a height of 3 mm. Then the long strip was polished to obtain an antistatic ceramic finished product of qualified size, shape, and surface quality.

### Example 5

An antistatic zirconia ceramic includes components of the following mass fraction:

| | |
|---|---|
| Zirconia | 70% |
| Yttrium oxide | 3% |
| MgAl₂O₄ | 25% |
| Nano-alumina | 2% |

The method of preparing the aforementioned zirconia composite ceramic includes the following steps of:

Step 1: according to the mass ratio of the zirconia in the table, the mass ratio of the zirconia was converted into a mass ratio of zirconium oxychloride in terms of molar ratio, and then 82 g/L aqueous solution was formulated. The MgAl₂O₄ was converted into a molar ratio according to the mass ratio, and then was converted into the mass ratio of the precursor oxide such as magnesium oxide and alumina. Next, the two oxides and yttrium oxide were dissolved with nitric acid to formulate 0.5 mol/L nitrate solution, respectively. Finally, the weighed material solutions were added to the reactor kettle, stirred evenly to form the mother liquor.

Step 2: the reaction and precipitation were carried out by a coprecipitation method. Deionized water having 3 times of the total powder mass and dispersant having 0.6% of the total powder mass were added into the reaction kettle. The dispersant was SD-05, and the temperature was slowly raised to 62° C. at a rate of 1° C./min. The concentrated ammonia having a mass fraction of 25% was selected as a precipitant, deionized water was added in the concentrated ammonia to formulate 3 mol/L precipitant solution. The solution prepared in step 1 and the ammonia were simultaneously added into the reactor kettle, and the reaction temperature was controlled at 62° C. Pay attention to adjust the flow of the two solutions, such that the pH value was maintained at 9, while stirring continuously to produce a hydroxide precipitate until the mother liquor had added. After completion of the reaction, the precipitate was aged for 3 hours, then filtered, and the precipitate was rinsed 5 times with deionized water. The rinsed precipitate was then placed in a lyophilizer, adjusted to a drying pressure of 20 Pa, and was lyophilized for 3 hours, thereby obtaining an antistatic zirconia precursor without hard agglomeration.

Step 3: the precursor obtained in step 2 was heated to 1000° C. at a rate of 1° C./min using an air resistance furnace and was held for 2 hours to obtain antistatic zirconia bulk powder.

Step 4: the bulk powder obtained in step 3 and the nano-alumina powder weighed by mass ratio were added to the ball mill together to carry out the wet grinding mixed. The grinding ball adopted a zirconia material grinding ball, the ratio of the material, ball, and water was 1:2:0.5, and the ball-milling time was 30 hours.

Step 5: the ball-milled powder was spray granulated to obtain an antistatic zirconia ceramic powder having a particle size of 0.8 μm and a specific surface area of 10 m²/g.

Step 6: the prepared zirconia antistatic ceramic powder was heated and stirred together with the paraffin having 20% of the powder mass, and then was hot-pressed to obtain a long strip having a length of 50 mm, a width of 10 mm, and a height of 8 mm.

Step 7: the shaped green body was embedded in a crucible with corundum powder to dewax, and then was placed into an air furnace for sintering. The heating rate is 1° C./min below 700° C. and 4° C./min above 700° C., until the maximum sintering temperature had reached. The maximum sintering temperature was 1380° C. and was held for 2 hours.

Step 8: the sintered zirconia antistatic ceramic was machined according to requirements to obtain a long strip having a length of 36 mm, a width of 4 mm, and a height of 3 mm. Then the long strip was polished to obtain an antistatic ceramic finished product of qualified size, shape, and surface quality.

### Comparative Example

| | |
|---|---|
| Yttria partial stabilized zirconia | 60% |
| Ferric oxide | 10% |
| Nickel oxide | 18% |
| Chromium oxide | 12% |

Step 1: yttria partial stabilized zirconia, ferric oxide, nickel oxide, and chromium oxide were weighed by mass ratio in the table, respectively, and then were added to the ball mill for physical mixing. Among them, the material:the ball:water=1:2:0.6, and the ball-milling time was 30 hours.

Step 2: PVA having 1% of the powder total mass was weighed. Then 10% PVA solution was formulated, which was added to the ball-milled slurry, stirred evenly.

Step 3: the PVA-added slurry was transferred to a storage tank with a stirring paddle, and then was spray granulated to obtain spherical powder.

Step 4: the obtained spherical powder was placed in a dry pressing mould and was molded into a long strip having a length of 50 mm, a width of 10 mm, and a height of 8 mm.

Step 5: the shaped green body was placed into an air furnace for sintering. The heating rate was 2° C./min until the maximum sintering temperature 1400° C. had reached, and then was held for 2 hours.

Step 6: the sintered rough was processed to obtain a long strip having a length of 36 mm, a width of 4 mm, and a height of 3 mm.

The density, resistivity, flexural strength, and hardness of the products prepared in Examples 1-5 and Comparative Example were tested as shown in Table 1.

Among them, the resistivity test using volume resistance tester, test temperature: 25° C., test humidity: 50%.

Density test using precision density balance, test temperature: 25° C.

Flexural strength using bending strength tester, the test method is a three-point bending strength test method.

Hardness test using Vickers hardness tester.

TABLE 1

| | | | | Flexural | |
|---|---|---|---|---|---|
| | | Density | Resistivity | strength | Hardness |
| Item | Color | (g/cm³) | (Ω · cm) | (MPa) | (GPa) |
| Example 1 | black | 5.70 | 10⁸ | 800 | 12.0 |
| Example 2 | gray green | 5.83 | 10⁷ | 850 | 12.3 |
| Example 3 | white | 5.65 | 10⁶ | 780 | 11.5 |
| Example 4 | yellow green | 5.68 | 10⁵ | 750 | 11.2 |
| Example 5 | gray | 5.66 | 10⁷ | 740 | 11.4 |
| Comparative | black | 5.60 | 10⁹ | 690 | 11.0 |
| Example | | | | | |

As can be seen from Table 1, the resistivity of the products prepared in Examples 1-5 was much lower than that of the comparative example. The density, flexural strength, and hardness of the products prepared in Examples 1-5 were higher than those of the comparative example.

Although the respective embodiments have been described one by one, it shall be appreciated that the respective embodiments will not be isolated. Those skilled in the art can apparently appreciate upon reading the disclosure of this application that the respective technical features involved in the respective embodiments can be combined arbitrarily between the respective embodiments as long as they have no collision with each other.

Although the description is illustrated and described herein with reference to certain embodiments, the description is not intended to be limited to the details shown. Modifications may be made in the details within the scope and range equivalents of the claims.

What is claimed is:

1. A zirconia composite ceramic, comprising: by weight percentage, 65% to 80% of zirconia matrix, 10% to 30% of conductive material, and 2% to 11% of nanometer reinforcing material, wherein the conductive material is at least one selected from the group consisting of nonferrous metal oxide, white metal oxide, compound having perovskite structure, and compound having spinel structure, the colored oxide is at least one selected from the group consisting of CuO, Cu₂O, V₂O₅, NiO, MnO, MnO₂, CoO, Co₂O₃, Co₃O₄, Fe₂O₃, FeO, Fe₃O₄, and Cr₂O₃; the white oxide is at least one selected from the group consisting of ZnO, SnO₂, and TiO₂; the compound having perovskite structure is at least one selected from the group consisting of CaTiO₃, BaTiO₃, LaCrO₃, LaSr_{0.1}Cr_{0.9}O₃, SrTiO₃, and LaFeO₃; the compound having spinel structure has a formula of AB₂O₄, wherein A is at least one selected from the group consisting of Mg, Fe, Zn, and Mn; B is at least one selected from the group consisting of Al, Cr, and Fe.

2. The zirconia composite ceramic according to claim 1, wherein the zirconia matrix comprises, by weight percentage, 2% to 10% of stabilizer and 90% to 98% of zirconia, the stabilizer is at least one selected from the group consisting of yttria, magnesium oxide, calcium oxide, and cerium oxide.

3. The zirconia composite ceramic according to claim 1, wherein the nanometer reinforcing material is at least one selected from the group consisting of nano-zirconia and nano-alumina.

4. A method of preparing a zirconia composite ceramic of claim 1, comprising the following steps of:
providing a zirconium oxychloride solution and a metal ion solution corresponding to the conductive material according to an amount of the zirconia matrix and the conductive material in the zirconia composite ceramic, and combining the zirconium oxychloride solution and the metal ion solution to obtain a mother liquor;
providing a dispersant solution and heating the dispersant solution to a temperature of 60° C. to 65° C., wherein a mass ratio of a dispersant in the dispersant solution to the zirconia in the zirconia matrix ranges from 0.5:99.5 to 1:99;
adding an ammonia having a concentration of 2 mol/L to 3 mol/L and the mother liquor into the dispersant solution simultaneously, controlling the reaction temperature at 60° C. to 65° C. and the reaction pH at 8 to 10, aging for 2 hours to 5 hours after the reaction is finished, drying after filtration to obtain a precursor;
sintering the precursor at a temperature of 800° C. to 1100° C. for 1 hour to 5 hours to obtain a bulk material;
ball-milling the bulk material and a nanometer reinforcing material for 24 hours to 48 hours to obtain zirconia composite ceramic powder;
granulating the zirconia composite ceramic powder to form a green body; and
heating the green body slowly to a temperature of 1280° C. to 1520° C. for sintering to obtain the zirconia composite ceramic.

5. The method of preparing the zirconia composite ceramic according to claim 4, wherein in the step of heating the green body slowly to the temperature of 1280° C. to 1520° C. for sintering, a temperature is raised to 700° C. at a heating rate of 0.5° C./min to 3° C./min, and then the temperature is raised to 1280° C. to 1520° C. at a heating rate of 4° C./min to 5° C./min.

6. The method of preparing the zirconia composite ceramic according to claim 4, wherein in the step of providing the zirconium oxychloride solution and the metal ion solution corresponding to the conductive material according to the amount of the zirconia matrix and the conductive material in the zirconia composite ceramic, the zirconium oxychloride solution has a concentration of 80 g/L to 85 g/L, the amount of the conductive material in the zirconia composite ceramic is converted to an amount of an metal oxide, the metal oxides are dissolved with nitric acid to formulate the metal ion solutions having a concentration of 0.4 mol/L to 0.6 mol/L, respectively.

7. The method of preparing the zirconia composite ceramic according to claim 4, wherein in the step of drying after filtration to obtain the precursor, a precipitate obtained after the filtration is rinsed with deionized water, and the precipitate after rinsing is lyophilized at 10 Pa to 40 Pa for 2 hours to 5 hours to obtain the precursor.

8. The method of preparing the zirconia composite ceramic according to claim 4, wherein the dispersant in the dispersant solution is at least one selected from the group consisting of SD-05, D3005, D900, and ammonium polyacrylate; and the dispersant solution has a concentration of 10 g/L to 30 g/L.

9. The method of preparing the zirconia composite ceramic according to claim 4, wherein in the step of granulating the zirconia composite ceramic powder to form the green body, the zirconia composite ceramic powder is spray granulated to obtain a powder having a particle size of 0.7 μm to 1 μm and a specific surface area of 8 m²/g to 11 m²/g.

10. The method of preparing the zirconia composite ceramic according to claim 4, wherein in the step of sintering the precursor at a temperature of 800° C. to 1100° C. for 1 hour to 5 hours to obtain the bulk material, the temperature is raised to 800° C. to 1100° C. at a heating rate of 1° C./min to 3° C./min.
